(19) United States
(12) Patent Application Publication
(10) Pub. No.: US 2026/0166352 A1
(43) Pub. Date: Jun. 18, 2026

(54) Fire Water Cannon, System, and Method for Fire Suppression

(71) Applicant: PHNIX FIRE, INC., Camarillo, CA (US)

(72) Inventor: James Gerard Dziadulewicz, Camarillo, CA (US)

(21) Appl. No.: 19/462,719

(22) Filed: Jan. 28, 2026

Related U.S. Application Data
(63) Continuation-in-part of application No. 19/245,250, filed on Jun. 20, 2025.
(60) Provisional application No. 63/661,861, filed on Jun. 19, 2024.

(51) Int. Cl. A62C 3/02

(52) U.S. Cl. CPC A62C 3/0292; A62C 3/0271

(57) ABSTRACT

A smart multi-axis lawn pop-up precision fire water cannon system and associated fire suppression method are disclosed. A processor controls the mode of operation of the fire suppression system and directs multi-axis pop-up precision fire water cannons in relation to a known structural layout of a property based on a 3D model of the property being protected. Notably, the multi-axis lawn pop-up precision fire water cannons are closed when not in use and are located outside the building to be protected, e.g., buried in the ground. The fire suppression system is capable of controlling water cannons automatically or under control of a remote user app. Onsite cameras are used alone or with ember traps or other fire sensors. Based on video and/or 3D information water cannon are able to direct water accurately and efficiently to put out flames as they arise and/or to prewet an area to reduce fire risk.

### RELATED APPLICATIONS

The present application claims the benefit of U.S. Provisional Patent Application 63/661,861 which was filed on Jun. 19, 2024 and is a continuation-in-part of U.S. patent application Ser. No. 19/245,250 which was filed on Jun. 20, 2025, both patent applications being hereby expressly incorporated by reference in their entirety.

### FIELD

The present application relates to fire prevention system and methods and more particularly to fire water cannons, fire suppression systems and methods for fire suppression, e.g., wildfire suppression.

### BACKGROUND

Wildfires present an increasingly greater risk to homeowners and residents in dwellings, no matter how near or far they are from firefighting services. This is a problem for individuals who wish to prevent fires from destroying or damaging their homes or other buildings. Consequently, many residents deploy and then plan to utilize water sprinklers or unguided water cannons as fire suppression/prevention devices.

In many cases the mounting of water cannons or sprinklers on the roofs of buildings is prohibited or discouraged for a variety of reasons including aesthetic reasons, the risk of tripping on pipes/sprinklers on rooftops and/or for other reasons. In addition, the tying of large numbers of outdoor sprinklers to public water systems that can be activated before or during a wildfire can present the risk of reducing water pressure at other locations. This can hinder firefighters ability to rely on public water systems and the water pressure normally available in such systems when it is needed most at critical locations.

In many cases sprinklers used by homeowners to spay water in the hope of reducing the risk of a fire threat were intended for farm watering applications and not fire suppression. As a result, while they may wet an area, they often distribute water in a manner which is not optimal for fire suppression with critical areas on or around a home treated in the same manner as other less important areas. In many cases, these conventional devices are configured to just spray water in a single direction, or spray water over a range in repeated fashion, without ever detecting where the greatest fire damage is happening. Thus, these conventional home fire devices fail to prevent all damage from fires and often fail altogether since fires can be relentless when not fully suppressed. In addition, in the case of a fire, water resources are limited whether the water is coming from a municipal system or an alternative water source. The use of general unguided spraying to wet a large area before or during a fire can result in poor use of the limited water available in such critical times.

In view of the above, it should be appreciated that there is need for new and improved fire suppression methods and apparatus relating to one or more of: fire suppression sprinklers/water cannon, control and/or use of such sprinklers/water cannon taking into consideration actual environmental conditions and or fire risks to different areas/parts of a structure.

It is desirable that at least some but not necessarily all aspects allow smart technology, e.g., sensors, artificial intelligence and/or processor control based on sensed data, to be used to protect homes structures, infrastructure, and/or site landscaping (hereinafter referred to collectively and individually as “property”) from the devastation and destruction of wildfires and/or other figures using available, e.g., limited amounts of water, in an efficient manner for fire suppression and/or prevention.

### SUMMARY

The test mode of operation in which the water cannons can be tested. During test mode the water cannons can be tested by spraying water and moved but environmental/building conditions are taken into consideration to avoid spraying water into the building where it might cause damage, e.g., due to an open window or injury to a person because a person is in front of a water cannon at the time of the test. The test mode can be triggered/controlled remotely e.g., via wireless signaling so that the home owner need not be present at the time of the test and can implement the test remotely.

The pre-fire mode of operation in which the water cannons are controlled to wet the property to be protected, e.g., by moving the spray in a predetermined pattern intended to wet the area to be protected.

The fire mode of operation is a mode of operation in which, the system controller, in response to the detection of fire, hot spots or embers on the home or in a location threating the home, controls one or more water cannons (normally multiple water cannons) to focus water spray (or some other fire retardant/suppression spray) on a detected threat. The targeting of water cannon spray is initially based on the predetermined known 3D relationship between a water cannon's expected spay pattern and the detected threat location. Once the spray is initiated towards a target, the water cannon spray is monitored by one or more video cameras and adjusted in real time based on camera footage as part of a control feedback loop, e.g., using the precision virtual 3D site model. This allows the system controller to correct for any error in the spray from a nozzle reaching the detected threat (fire or hot spot) due to wind or other unexpected or changing environmental conditions. During fire mode of operation open windows and/or other potential areas of water entry into the house are not avoided and, in some cases, prioritized for spray given the risk that such opens present as potential fire entry areas. Thus, during fire mode of operation areas of potential water entry into the home are treated differently than during test mode where such potential water entry locations are intentionally avoided to prevent water entry into the home during a test of the system.

The controller of the fire suppression system can automatically close automated windows and garage doors using home automation in the event of a fire or test mode operation.

In various embodiments the water cannons are normally concealed when not in use. In some embodiments, the water cannons are implemented as pop up devices with a hinged or other form of moveable lid being moved when the water cannon pops up. In other embodiments, the lid is a fixed lid above the water cannon which rises, and thus moves, with the water nozzle assembly when the water cannon is triggered to pop up. In other embodiments the lid is a single or multi-part, e.g. two part, lid which hinges away to allow the water cannon to pop up and be used and which automatically retracts when a water cannon is returned to its recessed state.

In some embodiments, the pop-up device covers slides horizontally a grooved motorized track that opens to allow the cannons to extend up and then retracts and seals along a rubber gasket.

Water cannons are controlled wirelessly or via wired connections to the system controller. The controller can control individual water cannons to rotate, e.g., o to 360 degrees and tilt, e.g., to direct water higher or lower. For example, a water cannon nozzle may taper from its water entry point to the water exist point with, in some cases, the water entry point to the nozzle being between 1″ and 1.5″ and the water outlet being between ½″ and ¾″ depending on the embodiment. In various embodiments water cannons can shoot between 50 and 300 feet or even greater distances allowing water sprayed from a ground based water cannon to easily reach roof tops several stores above the ground as well as multi-stories up the side of a building. Operating pressures of between 30 and 120 PSI and GMP gallons per min from 10-100 are common. The nozzle, water supply and operating pressures are exemplary and readily implemented using one or more conventional water pumps which can and sometimes are used to draw water from a pool, pond, storage tank or other local water source.

In various embodiments tapered water nozzles are used to increase water velocity. In some embodiments 1″ water supply lines supply a water cannon with water. However larger or smaller pipes/supply sizes are possible and used in some embodiments. In some embodiments water cannons are implemented as self contained, environmentally sealed canister assemblies from which the water cannon can pop up when controlled to do so through the use of water pressure and/or pneumatic an electrical drive used to raise the water cannon from a recessed position within the canister assembly.

The control of the system can be and sometimes is implemented automatically, under control of a processor located at the site, e.g., in the home or building, to be protected reducing the risk that a fire might prevent reliable and timely control of the system as might be the case if the controller was remotely located at a distant site. However, remote control of the system is also possible and supported in some embodiments as an alternative or in addition to the local controller control option. In addition, a homeowner or other system operator is provided the ability, via a user application on a cell phone or other user device, to remotely view camera output, control the mode of operation and/or prioritize certain areas to be sprayed by a water cannon.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing showing a site to be protected, e.g., a site with a home, with various components of an exemplary fire protection system implemented in accordance with the present invention positioned at and around the home to support detection and suppression of fires.

FIG. 2 shows the site shown in FIG. 1 with additional components of the exemplary fire protection system shown in FIG. 1 being visible.

FIG. 3 shows a controller which can be used in the fire suppression system shown in FIGS. 1 and 2 to control water cannon operation in accordance with the invention.

FIG. 4 shows the steps of a flow diagram of an exemplary method, implemented in accordance with the invention, of controlling a fire suppression system such as the exemplary fire suppression system shown in FIGS. 1 and 2.

FIG. 5 shows the steps of a standby mode subroutine which can be called by method shown in FIG. 4.

FIG. 6 shows the steps of a start pre-fire mode subroutine which can be called by the method of FIG. 4.

FIG. 7 shows the steps of a test mode subroutine which can be called by the method of FIG. 4.

FIG. 8 shows the steps of a fire mode subroutine which can be called by the method of FIG. 4.

FIG. 9 is a diagram showing the upper parts of a first exemplary water cannon that can be used in the system of FIG. 1.

FIG. 10 is a more complete diagram showing the first exemplary water cannon of FIG. 9 in more complete form.

FIG. 11 is a diagram showing how multiple water cannons of the type shown in FIG. 9 can be deployed in the ground around a site to be protected from fire.

FIG. 12 is a diagram showing a second water cannon canister assembly implemented in accordance with another embodiment of the invention with a second water cannon being shown in a deployed state ready to spray water.

FIG. 13 is a diagram showing the water cannon canister assembly including the second water cannon of FIG. 9 in a stored state with the lid of the canister in which the water cannon is stored being in a closed state and the water cannon being stored beneath the lid.

FIG. 14 is a diagram showing the second water cannon of FIG. 9 along with tilt and rotate position control motors with the components shown in greater detail than in FIGS. 12 and 13.

FIG. 16 shows a third water cannon embodiment in a deployed state with a monitoring camera mounted on or above the water cannon nozzle facilitating tracking of the water cannon spray and facilitating targeting of fires with the illustrated water cannon.

### DETAILED DESCRIPTION

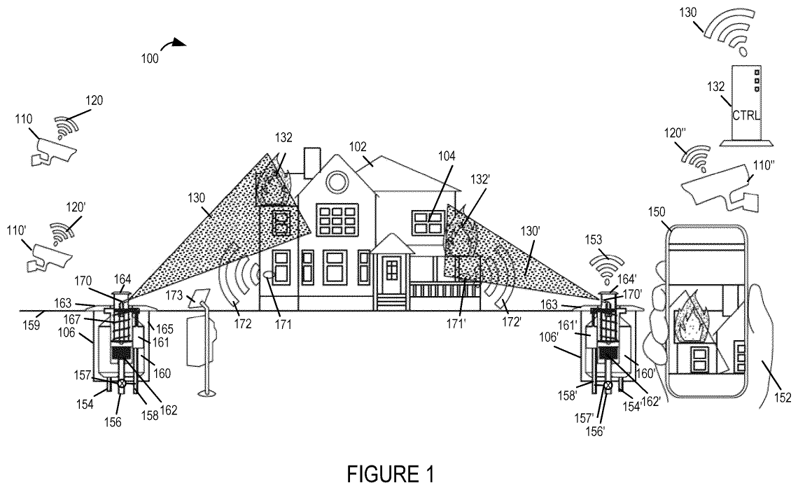

A fire suppression system 100 and various exemplary components of such a system will now be explained with reference to FIG. 1. FIG. 1 is a drawing 100 showing a site to be protected, e.g., a site with a building in the form of a home 102 and various components of a fire suppression system at the house. Various components of the exemplary fire protection system 100 implemented in accordance with the present invention, include components such as wireless cameras 110, 110′. 110″ positioned at and around the home 102 to support detection and suppression of fires.

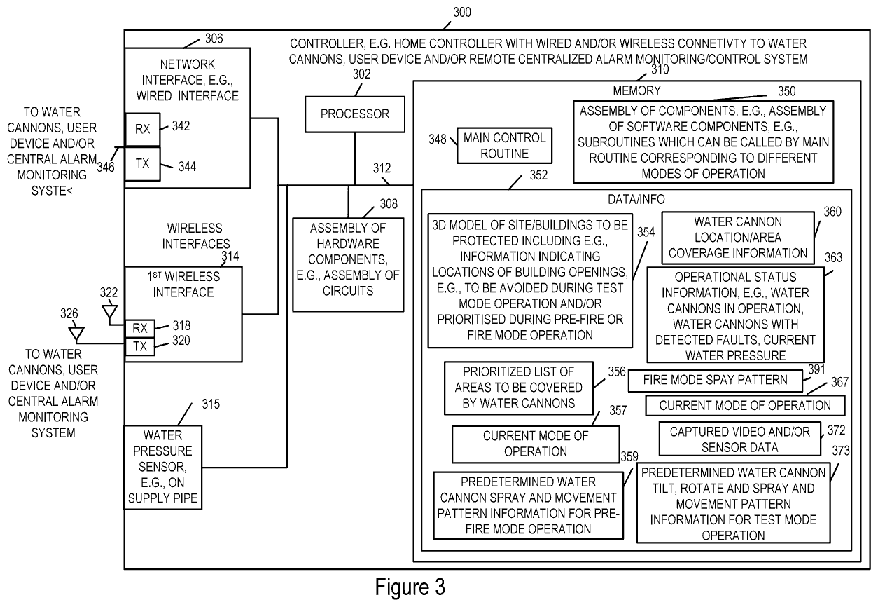

In the present application for purposes of simplifying the explanation of various devices, different devices which are the same or similar will be identified using the same reference number but with a ‘after the number to indicate a second instance of the device, a ‘’ after the number to indicate a third instance of the device and a ‘’’ to indicate a fourth instance and so on. Thus camera 110′ is a second wireless camera which is the same or similar to wireless camera 110 while camera 110″ refers to a third wireless camera which is the same or similar to wireless camera 110 and camera 110″′ is a fourth wireless camera which is the same or similar to wireless camera 110. Wireless signals 120, 120′, 120″ represent wireless camera transmissions, e.g., of video of the areas being monitored being communicated to system controller 132. System controller 132, which will be explained further with reference to FIG. 3 and the subsequent flow charts, receives signals 120, 12′, 120″′ from the cameras 110, 110′, 110″′ and other devices, e.g., ember detection system 173 and water cannon assemblies 106, 106″ and sends wireless control signals 130 to such devices and/or control signals via wire connections. While shown outside the house the controller 132 is normally located in the house 102 and/or at an offsite location with network connectivity to the home 102. The house 102 includes window such as windows 104 and is on ground represented by horizontal line 159.

Wireless repeaters 171, 171′ receive and retransmit wireless signals 120, 120′, 120″ and 130 to increase the range of such signals and ensure reliable communications between the components at the home 102 even in the case of wildfire conditions. Wireless signals 172, 172′ represent signal retransmissions by the repeaters 171, 171′ respectively.

In addition to the cameras, 110, 110′, 110″, controller 132, and ember detector 173, the fire suppression system 100 includes multiple water cannon assemblies 106, 106′ which can be controlled to spray water on one or more target area, e.g., areas corresponding to fires 132, 132′ which can be detected by processing the output of the wireless cameras 110, 110′, 110″.

In various embodiments, water cannon assemblies 106, 106′ are implemented in the form of canisters 165 with a top surface 163 from which a water cannon nozzle 170 can pop up when spraying of water is required. The water cannon assemblies 106, 106′ can be implemented in a variety of ways as will be discussed with regard to various embodiments described in other figures. In the FIG. 1 example the first water cannon assembly 106 includes a canister shell 165 with a top 163. The canister 165 is generally a cylindrical shell in which having a water drain 154, a water supply inlet 156, optionally a controllable water value 157, water filter 162, pop up return spring 167 and rotatable and tiltable nozzle 170. A water passage and/or water cavity 177 in some embodiments is used to allow water to flow from the inlet 154 through a filter 162 to nozzle 170 via a water nozzle supply tube 169 which can include one or more holes allowing water in the cavity 177 to flow up and out the nozzle 170 while water pressure pushes the pop up assembly up 175 up above the level of the ground in the water cannon assembly 106 is buried.

In some embodiments a coiled hose takes the place of pop up return spring 167. A controller 161 cam receive wireless control command and/or control command via cables entering via wire/power inlet 158. The controller 161 is responsive to received control signals, e.g., from controller 132 to generate a nozzle tilt control signal, a nozzle rotation control signal, a water control valve signal and/or a raise/lower (pop up) control signal. The nozzle tilt control signal controls a motor, e.g., a first stepper motor, which adjusts nozzle tilt under direction of the control signal. This allows nozzle 170 to be tilted up or down to a desired angle. The nozzle rotate control signals is used to control a second motor, e.g., a second stepper motor, which controls rotation of the nozzle 170 from 0 to 360 degrees. By adjusting the angle and/or rotation of the nozzle 170 the direction of spray can be adjusted so that the spray 130 can reach the target fire 132 on which water cannon 106 is trained. The water control valve signal is used to control water valve 157 when present which controls the flow of water through filter 162 and hose 167 to nozzle 170. In the event of a water cannon problem or low water pressure the controller 132 can shut off water valve 157 thereby cutting off the water to the first water cannon 106 while allowing water to flow to other water cannons such as second water cannon 106′.

The second water cannon 106′ includes the same or similar components as the first water cannon assembly 106 but with the element being identified using the same number as the corresponding element of water cannon assembly 106 followed by a ′. For example, nozzle 170′ of the second canister assembly 106′ is the same or similar to nozzle 170 of the first water cannon assembly 106. Reference number 153 is used to represent wireless control signals received by the controller 161′ of the second water cannon assembly, e.g., form controller 132.

In the FIG. 1 example the water cannon assemblies 106, 106′ are show spraying water 130, 130′ at fires 132, 132′ respectively and are thus in a deployed, e.g., popped up mode of operation. When not in use covers 164, 164′ retract with the water cannons nozzles so that they are flush with ground level 159. In the FIG. 1 example the covers 164, 164′ are fixed and remain above the nozzle 170 and will rotate as the nozzle assembly is rotated.

In some embodiments water pressure is used to raise up, e.g., pop up the nozzle assembly so that by turning on valve 157 to allow water into the water cannon causes the water cannon to pop up. A spring and/or gravity will cause the water cannon nozzle and 170 and cover 164 to retract when the water is turned off. In other embodiments a motor and screw drive or other lift mechanism is used to raise and lower the nozzle 170 and cover 164. In such embodiment controller 161, 161′ will generate a control signal to drive the lift motor to raise or lower the nozzle 170, 170′ when appropriate. The drain 154 allows water to exit, e.g., drain from, the interior 160 of the canister assembly 106.

While the controller 132 receives camera output and can detect and track fires based on the camera output, ember detector 173 can capture and detect wind blow fire embers. Based on capture of a hot ember, the ember detector 173 will be triggered and send a fire detected signal to the controller 132. The controller 132 will switch the fire suppression system 100 into an active fire suppression mode of operation, if not already in such a mode of operation in response to detecting a fire in received video or receive a fire detected induction form ember detector 173 which can communicate via a wired or wireless connection to the controller 132.

The wire inlet 158, 158′ of the water cannon assemblies allow control and power wires to enter the water canister assembly 106, 106′ but are sealed to prevent water entering the wires and/or control modules 161, 10′ in the water cannon assemblies. While shown as part of the water cannon assemblies, control modules 161, 161′ can be located external to the water cannon assemblies 106, 106′ and coupled to the components included therein via waterproof wire entries 158, 158′.

The controller 132 can receive control signals from a remote control center located at a distance to the home site to be protected and/or from a user device such as cell phone 150 which runs a control application through which a home owner or other system operator can view feeds from the cameras 110, 110′. 110″ as shown in FIG. 1 or take various control operations such as change the mode of operation of the first suppression system, run a test of the fire suppression system or prioritize particular areas of the house 102 for fire suppression. The hand 152 of a user/homeowner is shown holding the user device while the user views a camera feed from one of the cameras 110, 110′, 110″ in the FIG. 1 example.

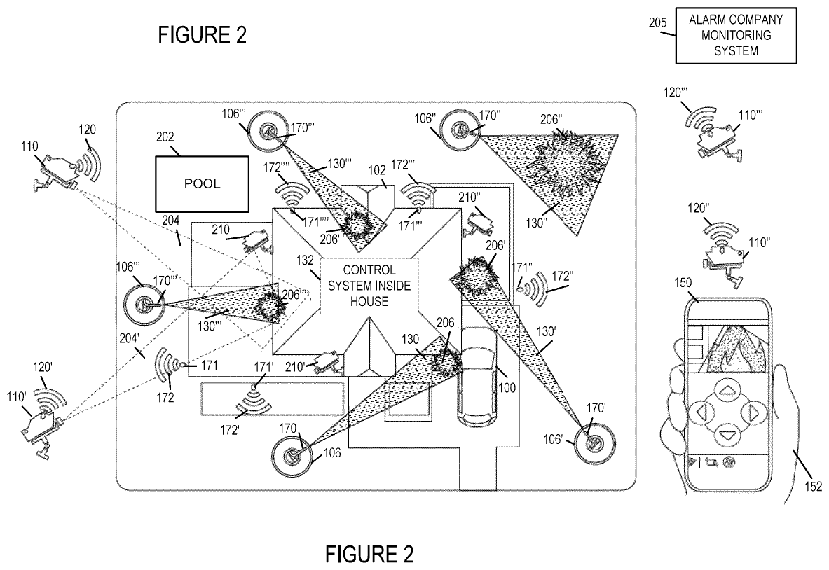

The fire suppression system of FIG. 1 is shown from a top looking down perspective in FIG. 2 with additional water cannon assemblies and corresponding water cannons being visible and being in use. In the FIG. 2 view, the pool 202 which is used as a source of water for the fire suppression system is visible in addition remote alarm company system 205 from which the fire suppression system can be controlled is also shown. In the FIG. 2 view in addition to wireless cameras 110, 110′, 110″, and 110″′ wired cameras 210, 210′, 210″ mounted on the house 102 are used to provide video to the control system 132 which is now shown inside the house 102 as represented by the use of dotted lines and the indication that the control system is inside the house 102.

In the FIG. 2 example, water cannon 106 is using nozzle 170 to spray fire 206 with 130 indicating the spray coverage area. Water cannon 106′ is using nozzle 170′ to spray fire 206′ with the spray 130′ corresponding to the stippled area identified by reference number 130′.

Watter cannon assembly 106″′ is using nozzle 170″ to spray fire 206″/ Water cannon 106″″ is using nozzle 170″′ to spray fire 206′″. In addition water cannon 106″″ is using nozzle 170″″ to spray fire 206″″. Area 204 corresponds to the area visible from and captured by wireless camera 110. Area 204′ corresponds to the area visible from and captured by wireless camera 110′.

In the FIG. 2 example a user is using user device 150 to view the output of one of the cameras in which a fire is visible and to manually steer. via controller 132, the water cannon 106″″ to direct water onto the fire 206″″.

An exemplary controller 300 which can be used in the fire suppression system controller 132 of FIGS. 1 and 2 is shown in FIG. 3.

The exemplary controller 300 includes a processor 303, wired network interface 306, a wireless network interface 314, a water pressure sensor (e.g., mounted on a water supply pipe used to supply water to one or more water cannon assemblies 106), an assembly of hardware components 308 and a memory 310 coupled together by bus 312. The network interface 306 is connected to wire 346 and allows the controller 300 to communicate via a wire connection 346 with water cannons 106, 106′, etc., user devices 150 and/or a central alarm monitoring system 205 by way of a wired connection 346. The water pressure sensor 315 is normally mounted on a water supply line and connected to the control system by a wire to provide water pressure information to the controller 300 to be taken into consideration in some embodiments when controlling water cannon usage, e.g., with the number of water cannons in use sometimes being dynamically adjusted up or down based on the measured/sensed water pressure at a given time.

The wired receiver 342 allows the wireline network interface 306 to receive signals while the wired transmitter 344 allows the network interface 306 to send commands and other signals.

The wireless network interface 314 includes a wireless receive 318 coupled to receive antenna 322 and a wireless transmitter 320 coupled to transmit antenna 326. The wireless receiver 318 allows the wireless network interface 314 to receive signals while the wireless transmitter 320 allows the wireless network interface 314 to send commands and other signals. The wireless network interface allows for wireless communication with water cannons 106, 106′, user device 150 and/or alarm company monitoring system 205. Received signals and signals to be transmitted can be communicated over bus 312 which allows the processor 302, memory 310 and assembly of hardware components to exchange information and signals.

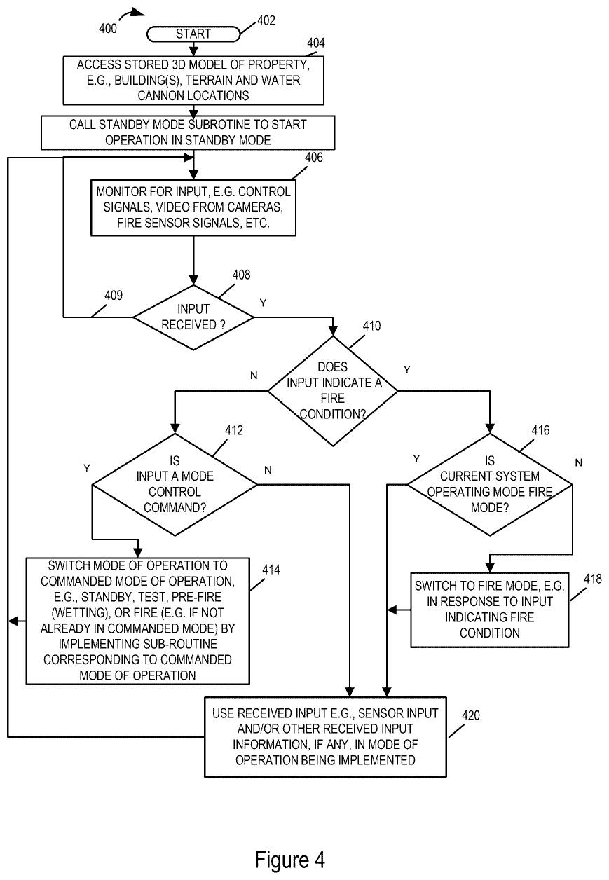

Memory 310 includes a main control routine which can call one or more subroutines stored in the assembly of components 350. The amin control routine 348, when executed by processor 302, control the controller 300 to interact with other components such as cameras 110, water cannons 106 and ember detector 173 to control the water cannons in accordance with the present invention. The steps of an exemplary main control routine will be explained with regard to the flow chart shown in FIG. 4.

To support various modes of operation, the memory 310, includes in addition to the main routine 348 and subroutines 350 data and information 352. In some embodiments this includes one more or all of a 3D model 354 of the site and/or buildings to be protected, water canon location and corresponding water cannon spray area coverage information 360, operational status information 363, e.g., information indicating such things as water cannons in operation, water cannons with detected faults, current water pressure, etc. The information 352 further includes current mode of operation information 357, e.g., information indicating whether the fire suppression system is operating in a standby mode of operation, a test mode of operation, a pre-fire mode of operation or a fire mode of operation. Captured video and/or sensor data 372 is also included in memory portion 352 and can be used to support viewing and/or prioritization of different areas for spray purposes. In some embodiments the full set of water cannons 106 may not be used simultaneously, e.g., due to water pressure or other issues. A list of prioritized areas to be covered by water cannons 356 is generated and stored in memory and used to prioritize which areas should be sprayed and/in the case of limited water pressure which water cannons should be used/not used as a given time due to water pressure constraints. The memory 310 also includes predetermined water cannon spray and movement pattern information for pre-fire mode operation which was generated based on the 3D information regarding the site to be protected and water cannon location information. Information 359 is used to control water cannon spray and movement during pre-fire mode operation when the spraying is performed independent of detection of an actual fire at the site. The stored information ensures spraying and thus wetting of high fire risk areas such as windows and building openings which are avoided during test mode operation. Shrubs at risk of catching fire can also be prioritized for spraying in the information 359. The spray pattern and movement resulting from use of the information 359 results in intentional non-uniform wetting of the area subject to spray with high risk areas such as building openings and shrubs near a building being sprayed more heavily and thus wetted, more than other areas, e.g., low risk fire areas, in some embodiments.

The operation of the fire suppression system 100 including the controller 300 which can be used as control system 132 shown in FIGS. 1 and 2 will now be explained with references to FIG. 4-8. FIG. 4 shows the steps of a flow diagram of an exemplary method, implemented in accordance with the invention, of controlling a fire suppression system such as the exemplary fire suppression system shown in FIGS. 1 and 2.

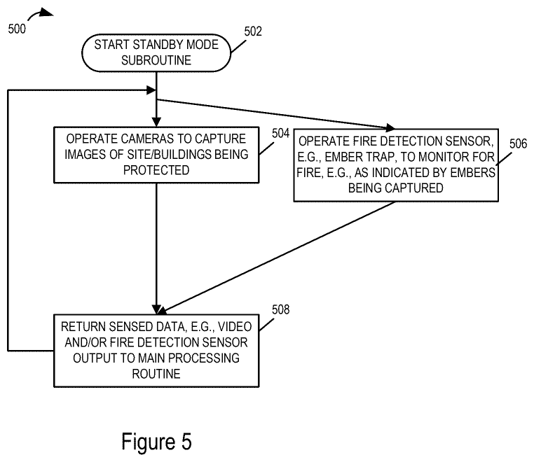

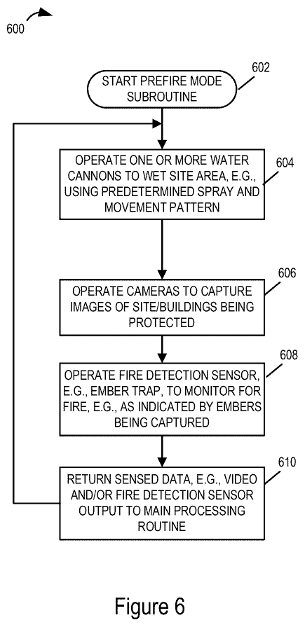

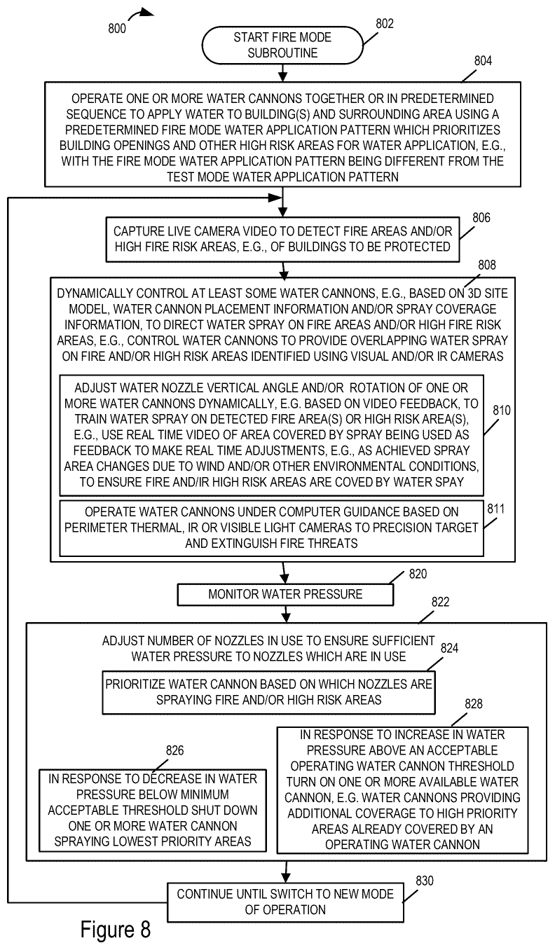

FIG. 4 shows the steps of the main control routine 348 which can be executed by processor 302 to control the components in the fire suppression system in accordance with the invention. The main control routine can make calls to the sub-routines shown in FIGS. 5-8 when a particular mode of operation is to be implemented. For example, the subroutine 500 show in FIG. 5 will be called when the main control routine determines that the system is to operate in a standby mode of operation. The subroutine 600 shown in FIG. 6 will be called when the main routine determines that the fire suppression system is to operate in a pre-fire mode of operation. The subroutine 700 will be called when the fire suppression system is to operate in a test mode of operation. The subroutine 800 of FIG. 8 will be called when the fire suppression system is to operate in a fire, e.g., fire suppression, mode of operation.

Turning now to the flow chart 400 shown in FIG. 4, the method starts in start step 402 with the controller 132 or 300 being powered on and the processor 302 beginning execution the main control routine 348 which then starts to control the controller 300 and fire suppression system components, e.g., water cannon assemblies 106, 106′, cameras 110, 110′, 110″, ember detector 173.

From start step 402 operation proceeds to step 404 in which a stored 3D model of the site, e.g., building 102, surroundings and locations of system components is accessed for use in fire suppression system control operations such as determining the location of fires detected in captured video images, determining which fire cannons can spray the detected fires and/or to prioritize water cannons for use, e.g., given detected fires and/or water supply or water pressure constrains. The 3D information also includes and provides information about predetermined water cannon pre-fire spray patterns/movements to employ, e.g., as part of a pre-fire wetting plan. In addition, in some embodiments, the 3D model 354 stored in memory 310 includes information about window and other building opens to be avoided during system test mode operation as well as building openings to be prioritized for water application during pre-fire and/or fire modes of operation. The 3D model information is obtained, in some embodiments from building and/or site plans and stored in the memory 310 in accordance with the invention prior to execution of the steps of the main routine 400.

With the 3D model 354 information accessed and available for use, operation proceeds from step 404 to step 405 in which the standby subroutine 300 of FIG. 5 is called so that system operation starts in standby mode. With operation in standby mode having been initiated operation proceeds to monitoring step 406. In step 406, which is performed on an ongoing basis, the processor 302 monitors for system input. The input maybe, for example, video signals from cameras 110, 110′, 110″, 210, 210′, sensor 173, water pressure measurement device 315, user device 152 and/or a remote monitoring system 205. A check is made in step 408 to determine if input was received and if input was received operation proceeds to step 410. Whether or not input was received monitoring for input will continue to be performed on an ongoing basis are represented by arrow 409 returning to monitoring step 406.

In step 410 a check is made as to whether the received input indicates a fire condition, e.g., if the input indicates detection of embers by the ember detector 173 or, in the case of video or still images including possibly thermal images, includes an image which shows a fire in the image as may be indicated by a heat value above some present threshold or an image including a fire which can be detected using pattern recognition or other image processing techniques. If the input indicates a fire condition, operation proceeds from step 410 to step 416. In step 416 the current fire suppression system mode of operation, indicated in memory portion 367, is checked to determine if it is the fire mode of operation, e.g., the mode in which detected fires will be automatically suppressed by targeted water cannon usage. It in step 416, if it is determined that the system is not already in fire mode operation, operation proceeds from step 416 to step 418. In step 418 the controller switches the mode of fire suppression system operation to fire mode of operation which in some embodiments involves a call to the fire mode of operation subroutine shown in FIG. 8 which will be discussed further below.

Operation proceeds from step 418 which involved the switch to fire mode operation or from step 416 in the case where the system is already in fire mode operation to step 420 so that any sensor (e.g., camera) or other input can be used in controlling fire suppression, e.g., given the detected fire(s).

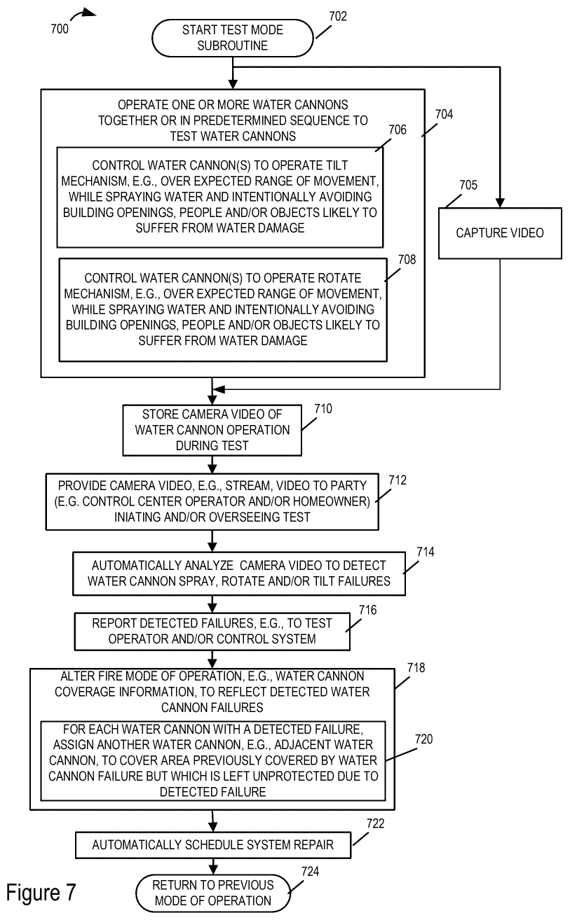

In step 410, if the received input to be processed does not indicate a fire condition, operation proceeds to step 412 in which the input is checked to determine if it is a mode control command. If the received input is a mode control command operation proceeds to step 414 in which the fire suppression system is switched into the mode of operation commanded by the received mode control command. In various embodiments, this operation involves a call to a sub-routine corresponding to the commanded mode of operation. For example, a command to switch to standby mode operation results in a call to subroutine 500 shown in FIG. 5. A command to switch to pre-fire mode of operation causes a call to the pre-fire mode subroutine shown in FIG. 6. A command to switch to a test mode subroutine causes a call to the test mode subroutine 700 shown in FIG. 7 and a call to switch to a fire mode of operation causes a call to the fire mode subroutine 800 shown in FIG. 8. If a command to switch to a mode of operation commands a switch to a mode in which the fire suppression system is already operating, the system will continue operating the commanded mode without the need to change the mode of operation. The called sub-routine will then be used to control fire suppression system operation until another change in the mode of operation is implemented.

Operation is shown proceeding from step 414 back to monitoring step 406 to show that monitoring for other input, e.g., such as video or other sensor input, will continue with the input being processed as it is received and that receipt of a mode control command does not halt or interrupt the receipt and processing of video and/or other sensor data.

If in step 412 it is determined that the input is not a mode control command, operation proceeds from step 412 to step 420 so that the received input, e.g., video, sensor data and/or user input can be processed and used during the mode of operation being implemented by the fire suppression system. In step 420 the received input, e.g., sensor data including ember detector output, water pressure information from water pressure sensor 315, video and/or other input information is processed and used as part of implementing the mode of operation being implemented.

The various sub-routines used to control operation of the fire suppression system 100 will now be discussed with reference to the individual figures that show exemplary sub-routines corresponding to particular modes of operation.

FIG. 5 shows the steps of a standby mode subroutine 500 which are executed when the subroutine 500 is called by the main control routine, e.g., at part of a switch to the standby mode of operation. The standby mode subroutine starts in step 502 when called, e.g., from the main control routine 400 of FIG. 4 and then proceeds to steps 504 and 506 which can be and sometimes are performed in parallel. In step 504 the cameras 110, 110, 110′″, 210, 210′, 210″ are operated to capture images, e.g., images of portions of sites and/or buildings being protected.

In step 506 the fire detection sensor, e.g., ember trap 170, is operated to detect a fire condition, e.g., as evidenced by the detection of embers in the ember trap 170. The video and ember trap sensing can be performed in parallel, e.g., asynchronously, with the captured video and fire detection sensor data being provided to reporting step 508 in which the sensed data, e.g., video and/or fire detection sensor output, are retuned to the main control routine 400, e.g., for processing and determination if a fire has been detected requiring operation in a fire mode of operation rather than the standby mode of operation. The video capture, detection sensing and reporting performed in the standby mode will continue on an ongoing basis. In addition, while other modes of operation are ongoing such image capture and reporting will continue to be performed even after switching from the standby mode of operation so that video and sensor 170 remain available. The ongoing sensing and reporting are represented by the arrow extending form return sensed data step 508 to video capture and sensor steps 504, 506.

Referring now FIG. 6 shows the steps of a start pre-fire mode subroutine 600 which can be called by the method of FIG. 4, e.g. as part of a switch to a pre-fire mode of operation used to wet all or some portions of the area to be protected by wetting the area using one or more water cannons.

Subroutine 600 stares in start step 602 and proceeds to step 604 in which one or more water cannons 610 are operated to wet the site area to be protected, e.g., using a predetermined spay and movement pattern. By controlling multiple water cannons the area to be protected can be wet down in attempt to reduce the risk of building and/or brush in the area catching fire. The predetermined spay and movement pattern used during the pre-fire mode of operation intentionally sprays building opens and other areas avoided during test mode operation to reduce the risk of fire despite the risk of water potentially entering a building to be protected. This is because in the case of a high risk of a fire, such areas are particularly important to protect give the risk of embers entering such openings and the potential risk of damage due to water entering the building is low compared to the risk and potential cost of the building burning down. In some embodiments stored predetermined water cannon nozzle and movement information 359 is used to control the movement and spraying of water cannons during the pre-fire mode of operation to ensure wetting of high risk fire areas at a higher rate than low risk fire areas.

In step 604 the cameras 110, 110′, 110″, 210, 210, 210″ are operated to capture images of the stie/buildings being protected and in step 608 the fire detection sensor 170 is operated to monitor for embers indicative of a fire. Steps 604, 606, 608 are shown as sequential steps but are normally performed in parallel in an asynchronous fashion. Data captured in steps 604, 606, 608 is returned to the processor 302 and used by the main control routine to determine if a switch should be made from the pre-fire mode of operation to the fire-mode of operation, e.g., due to data indicating a fire is present and/or has been detected. Steps 604, 606, 608, 610 are performed on an ongoing basis during the pre-fire mode of operation as represented by the arrow extending from step 610 back to step 604.

The test mode subroutine 700 of FIG. 7 will now be discussed. The subroutine 700 starts in step 702 with operation then progressing to step 704 in which one or more water cannons are operated together or in a predetermined sequence to test water their ability to spray, tilt and rotate as expected if operating properly. Step 704 includes in some embodiments steps 706 and step 708. In step 706 the water cannons 610, 610′ are operated to tilt the nozzle assemblies over an expected range of motion thereby testing whether the nozzle in the water cannon will be able to be tilted up and down during other modes, e.g., fire mode and/or pre-fire mode, of operation. In step 708 the water cannons 610, 610′ ability to rotate is tested by rotating the nozzle of the water cannon of the range of motion to be supported. Tilting and rotating performed in steps 706 and 708 as part of a test operation are in some embodiments performed while water is sprayed from the cannons being moved and the spray pattern monitored by the cameras. The spray pattern and movements are in accordance with a predetermined tilt, rotate and spray test pattern information stored 372 in memory 310. The stored test pattern information 372 is different from the stored pre-fire wetting patterns 359 with the test pattens for water cannons 610, 610′ taking into consideration there location and opening/objects in the potential spray area with the test patterns being designed to intentionally avoid windows and building openings while still allowing for the full tilt and rotate range to be tested. In many cases the test spray and movement pattern associated with a water cannon 610 or 610′ involves spraying away from the building 102 to be protected while during pre-fire and fire modes of operation the spray from the water cannons is intentionally directed towards the building 102 to be protected. Capture video step 705 is performed using cameras 110, 110′, 210, 210′, etc. in parallel with step 704 so that visual evidence of water cannon operation can be captured and checked to detect water cannon faults.

In step 710 captured camera video is stored and then provided, e.g., streamed, to processor 302, a party of interest or remote alarm monitoring system 205 for monitoring and checking for faults. In step 714 the camera video is analyzed, e.g., by processor 302 or another device to detect faults, e.g., failures of one or more cannon assemblies 610, 610 prime to support proper nozzle tilt and rotate operations. In step 716 detected water cannon related failures are reported to an operator or monitoring system 205 then in step 718 the fault condition information is processed to alter fire mode of operation, e.g., water cannon coverage information, to reflect detected water cannon failures so that during fire mode operation individual water cannons are not directed to spray areas which they are incapable of reaching e.g., due to a tilt or rotate problem with an individual water cannon. As part of step 718 in some embodiments step 720 is performed. In step 720 for each water cannon with a detected failure, another water cannon 610 or 610′ is assigned to be used during fire mode operation to cover an area which would otherwise be unprotected due to the detected failure of a water cannon. Normally an adjacent water canon is assigned as part of step 720 to cover an area previously covered by a water cannon with a detected fault condition. In step 718 defective water cannons can be and sometimes are taken out of use by setting control information that ensures that the defective water cannon will not be activated, e.g., its valve opened, during a fire to avoid potential wastage of water that can not be directed as intended due to a rotate or tilt failure.

Operation proceeds from step 718 to step 722 in which the controller 320 or remote monitoring system 205 automatically schedules a repair of the defective water cannon 610 or 610′, e.g., by sending a message to a repair service reporting the detect fault and scheduling a repair of the system.

The test mode of operation can be activated remotely and is sometimes activated on a predetermined schedule or when a fire is likely to occur to make sure that system is operating properly and that detected faults can be taken into condition and compensated for, e.g., by use of an alternative water cannon, if a switch to fire mode operation is required before system repair is completed.

Operation proceeds from step 722 to return step 724 in which system operation is returned to the mode of operation which was ongoing before test mode operation was initiated.

Fire mode operation will now be described with reference to Figure

FIG. 8 shows the steps of a fire mode subroutine which can be called by the method of FIG. 4.

The fire mode subroutine 800 starts in step 802 when called from the main routine. Operation proceeds from step 802 to step 804 in which one or more water cannons are operated together or in a predetermined sequence to apply water to buildings 102 and the surrounding area using a predetermined fire mode water application pattern stored in memory 310 which prioritized building openings and other high risk areas for water application, e.g., with the fire mode water pattern 391 for one or more water cannons being different from the test mode water application pattern used during test mode operation.

Operation proceeds from step 804 to step 806 in which camera video is captured and processed in real time to detect fire areas and/or areas at high risk of fire and their location in 3D space to allow for prioritization of areas, e.g., building areas, to be sprayed. Operation proceeds from step 806 to step 808 in which the processor 302 and thus controller 300 dynamically control at least some water cannons 106, 106′, e.g., based on 3D site model information, to direct water spray 130, 130′ on fire areas 206, 206′ and/or high fire risk areas. In some embodiments this involves directing a first two axis water cannon 106 on a first detected fire 206 and a second two axis water cannon 106′ to spray water on a second detected fire 170′ with video then being used to control the direction of each of these water cannons as part of a video feedback based control process.

As part of step 808 in some embodiments steps 810 and 811 are performed. In step 810 the processor 302 adjusts the vertical and/or rotation of one or more water cannons dynamically, e.g., based on video feedback to train water spar on detected fire areas or high risk areas. In some cases this involves adjusting the tilt of nozzle 170 of water cannon 106 and/or rotating the direction in which the nozzle of water cannon 106 is facing to target fire 206. Thus as wind or other conditions affect spray direction, the video feedback allows for real time adjustments to compensate for such conditions without having to measure the wind or other condition affecting the targeting process since video of the actual spray area is used to control the adjustments in tilt and rotational direction. Similarly the second water cannon 106′ is controlled to target fire 206′ as part of the video feedback and control process.

In step 811 which is performed as part of step 808 in some embodiments, water cannons 106, 106′, etc. are operated under processor 302 guidance based on the output of thermal cameras, IR or visible light cameras 110, 110′ located around the perimeter of the building 102 to be protected allowing for precise and targeted spray control of one or more water cannons which are controlled to spray and extinguish detected fires, e.g., before they get out of control.

Operation proceeds from step 808 to step 820 which is performed in embodiments where water pressure monitoring is supported through use of a water pressure sensor 315. Operation proceeds from step 820 to step 822 in which the number of water cannons/nozzles in use is adjusted to ensure sufficient water pressure to nozzles which are in use as necessary given the detected water pressure.

Step 822 includes in some embodiments one, more than one, or all of steps 824, 826 and 828. In step 824 water cannon are prioritized based on which nozzles are spraying fires and/or high risk areas to make sure that these water cannon remain in use in the event a reduction in the number of water cannons being used is required to maintain sufficient water pressure. In step 826, in response to detecting a decrease in water pressure below a minimum acceptable pressure threshold, one or more water cannon are shut down with the water cannon being shut down being the lowest priority water cannon, e.g., water cannon not spraying fires, while water cannon spraying fires are left in use. In step 828 in response to detecting an increase in water pressure above an acceptable operating water cannon pressure threshold that is higher than the minimum acceptable water pressure threshold, one or more water cannons which were turned off are turned on thereby providing additional spray coverage to high priority areas already covered by an operating water cannon or other areas which were not receiving water cannon spray.

Operation proceeds form step 822 to step 830 in which operation continues until a switch to a new mode of operation, e.g. because fires are no longer detected. An arrow is shown extending from step 830 to step 806 to show that steps 806 to 822 will be performed on an ongoing basis during fire mode operation.

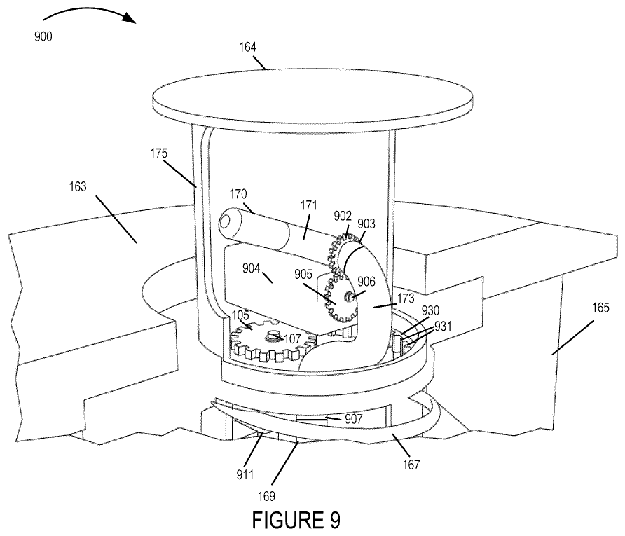

FIG. 9 is a diagram 900 showing the upper parts of a first exemplary water cannon that can be used in the system of FIG. 1. In FIG. 9 the lid 164 is shown above the surface 163 indicating it is in a popped up state. The illustrated water cannon 900 includes a popup assembly 175 in which nozzle 170 is positioned. The water cannon 900 includes a popup multiaccess water nozzle assembly 175 which includes a nozzle (170); a first rotatable water supply pipe 171 connected at a first end to the nozzle (170) (e.g., using threads, press on connection or via direct connection (e.g., metal to metal)), a second rotatable water supply pipe 173 movably connected to the first rotatable water supply pipe 171 (e.g., using a rotatable water tight connection or coupling), said first rotatable water supply pipe 171 being at least partially rotatable around a first axis (e.g., the water supply pipe portion 171 is rotatable in the vertical direction (up/down) as the portion 171 moves around a horizontal axis corresponding to the horizontal axis of vertical drive gear shaft 906 on which gear 905 is located, gear 905 being engaged with and driving vertical direction drive gear 902 as vertical drive motor assembly 904 turns drive shaft 906, said second rotatable water supply pipe 173 being at least partially rotatable around a second axis, e.g., a vertical axis corresponding to horizontal direction motor drive shaft 107, which extends in the vertical direction and drives horizontal direction drive gear 105 which is mounted on shaft 107. Horizontal direction drive gear 105 has teeth which engage teeth 931 of nozzle head assembly horizontal direction drive gear 930 with rotation of horizontal direction drive gear 105 causing the nozzle head assembly (175) to rotate which in turn causes rotation of nozzel portion 173 around a vertical axis). Water is supplied from a water inlet 156 (e.g., e.g., threaded opening for connection to a water supply line or other opening formed from walls of canister housing 165) which is in fluid connection to the second rotatable water supply pipe 173 (e.g., via a flexible tube or water passage/cavity 177) for supplying water through the second rotatable water supply pipe 173 and first rotatable water supply pipe 171 to the nozzle 170.

In FIG. 9 vertical nozzle orientation gear 902 is mounted on a water tight rotatable coupling 903 which has an outlet portion coupled to pipe section 171 and an inlet portion coupled to pipe 73. The as gear 902 rotates the outlet portion of the coupling 903 will rotate while the inlet remains fixed to pipe 173. In FIG. 9 a second rotatable coupling 907 is used to couple the second pipe portion 173 water inlet tube 169 through which water received via the water inlet 156 is supplied to second pipe portion 173. Reference number 911 is used to indicate a horizontal drive motor with shaft 107 that extends upward in a vertical direction and which can be used to rotate horizontal orientation drive gear 105 to cause the nozzle assembly 175 to rotate. The return spring 167 is visible in FIG. 9 and will cause the pop up assembly 175 to retract so that lid 165 is flush with the surface 163 when water pressure is cut off and the nozzle 170 is not in use.

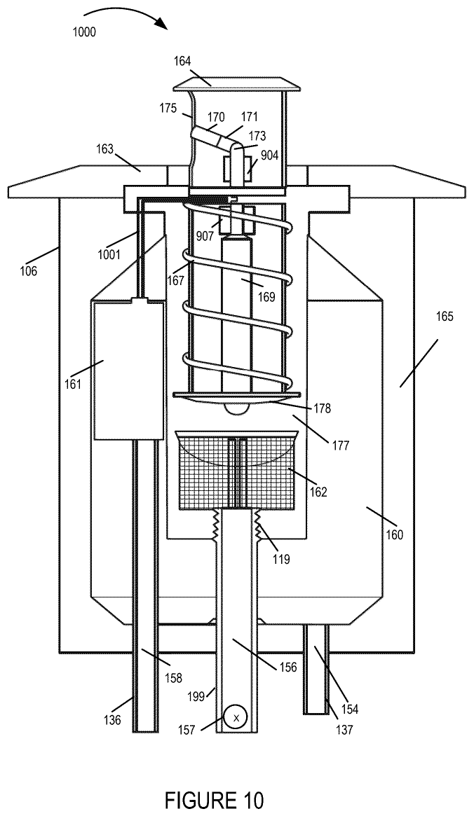

FIG. 10 is a more complete diagram 1000 of canister pop up nozzle assembly 106 a portion of which is shown in FIG. 9. FIG. 10 is a cut away view showing the first exemplary water cannon of FIG. 9 in more complete form. In the FIG. 10 example motor controller 161 can be seen with control lines 1001 extending to the horizontal orientation control motor 907 and to the vertical nozzle orientation control motor 904. In FIG. 9 threads 119 which can be used to secure a water inlet pipe 199 to a water filter 162 located inside water storage cavity 177 which is also a water passageway is shown. When volve 157 is opened, water will through pipe 199 up through water inlet 156 in the bottom of the housing 165 through the filter 162 into cavity/passage way 177. The water pressure in cavity 177 places upward pressure on the popup assembly 175 causing spring 167 to contract and the nozzle 170 to extend above 163 to a position where it can be used to spray water. Water passing through the water passage way 177 will flow through water inlet tube 169 and up through rotatable coupling 907 into the second pipe portion 173 and then in to the first pipe portion 171 and out through nozzle 170. Vertical nozzle position control motor 904 is controlled by controller 161 to control the vertical orientation of nozzle 170 while controller 161 controls horizontal nozzle orientation control motor 907 to rotate the nozzle 170 and first and second pipes 171, 173 in a horizontal direction around the vertical axis as needed to achieve the desired position of the nozzle 170 in any of 360 degrees which are possible.

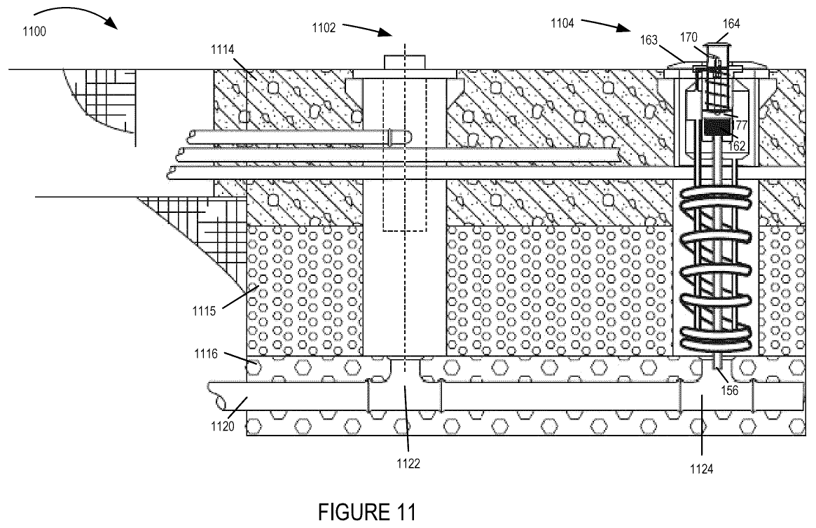

FIG. 11 is a diagram 1100 showing how multiple water cannon assemblies generally indicated by the reference numbers 1102, 1104 of the type shown in FIGS. 9 and 10 can be deployed in the ground around a site to be protected from fire. In the FIG. 11 example the water cannon assemblies 1102, 1104 are shown extending through 3 layers of ground 1114, 1115 and 1116. The water pipe 1120 is positioned in the lower ground layer 1116 with tees 1122 and 1124 providing water connection points, respectively, to the water inlets of the fist and second water cannon assemblies 1102, 1104.

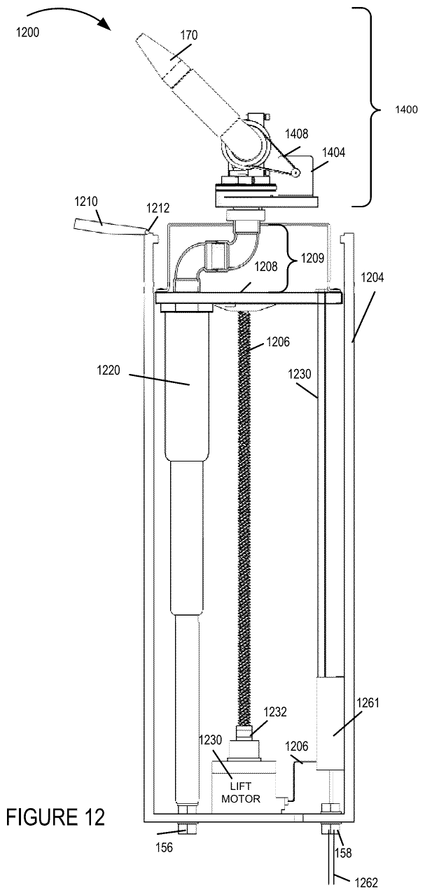

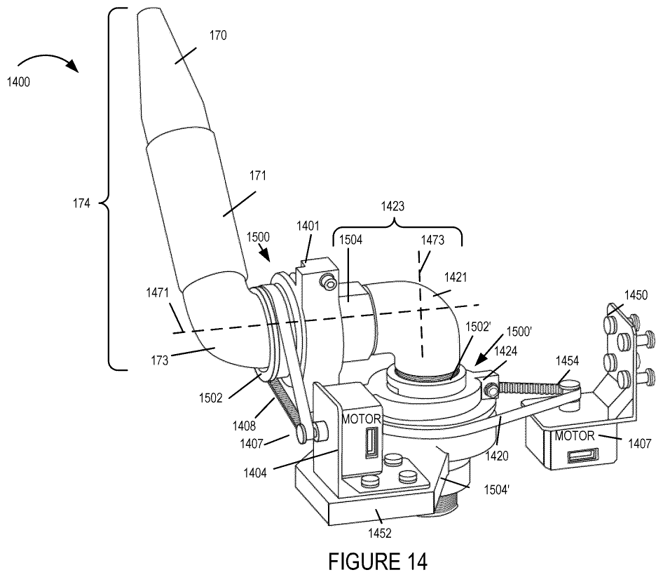

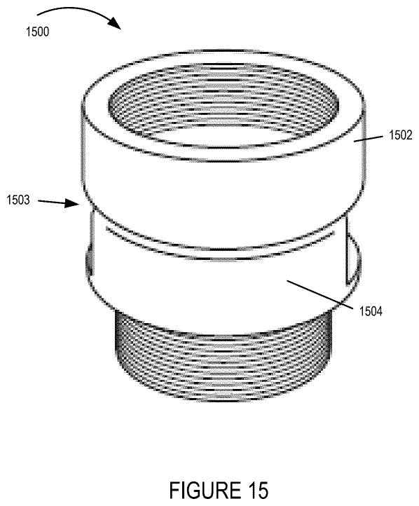

FIG. 12 is a diagram showing a second water cannon canister assembly 1200 implemented in accordance with another embodiment of the invention with a second water cannon being shown in a deployed state ready to spray water. In the FIG. 12 example a water nozzle assembly 1400 uses belts rather than gears to control horizontal and vertical rotation of the nozzle 170. Also, in the FIG. 12 example a hanged lid/cover 1200 is attached to a hinge 1212 and swings back when the nozzle assembly 1400 is mechanical raised via lift motor 1230 rotating drive screw 1206 causing the screw 1206 to raise or lower support platform 1208 as it rotates and passes through threaded rod support 1232. In some embodiments rod 1206 is a simple threaded rod but in other embodiments it is a telescoping threaded rod. In the FIG. 12 embodiment a telescoping supply tube 1220 is used to couple water inlet 156 to a rotatable coupling used to supply water to the nozzle assembly 1400. In some embodiments the hinge 112 includes a spring which spring loads the lid 1212 causing the lid to close when the nozzle assembly 140 is lowered into the canister housing 1204 in which the nozzle assembly 1400 is stored not in use. In the FIG. 12 embodiment the controller 1661 controls the lift motor 1230 to rotate to raise/lower the nozzle assembly 140 as needed while also controlling horizontal and vertical positioning motors to control the horizontal and vertical orientation of nozzle 170. Number 1205 is used to indicate a lift assembly including screw 1206, lift motor 1239 and rod support coupling 1232. Control lines pass from the controller 1261 through wire conduit 1230 to reach the horizontal and vertical position control motor in nozzle assembly 1400 which is shown in greater detail in FIG. 14. The controller 1261 is coupled to the control system 132 inside the house 102 which controls the multi-axis water cannon assembly 1400 and the lifting/lowering of the water cannon assembly 1400. When not in use controller 161 controls the lift motor 1230 to lower the water cannon assembly 1400 beneath the level of the lid 1210. When the water cannon assembly is to be deployed for use, e.g., to spray water, the lift motor 1230 is controlled to raise the water cannon assembly 1400 to that the nozzle 170 is above the top of the canister housing 1204 and is free to rotate in the vertical and horizontal directions under control of the controller 1261 which drives the vertical and horizontal position control motors of the water cannon assembly 1400.

In the FIG. 12 embodiment a pair of pipe elbows 1209 are used to couple the outlet of extendable tube 1220 to the water inlet of the nozzle assembly 1400.

In the FIGS. 12, 13 and 14 examples a fire suppression water cannon system 1200 or 1300 comprises a multi-axis nozzle assembly (1400) including: a nozzle (170); a first rotatable water supply pipe assembly (174) having a first end to which said nozzle (170) is secured, said first rotatable water supply pipe assembly (174) being rotatable around a first axis (1471) (e.g., a horizontal axis) allowing for adjustment of a vertical orientation of said first rotatable water supply pipe assembly (174); and a second rotatable water supply pipe assembly (1423) coupled to said first rotatable water supply pipe assembly (174), said second rotatable water supply pipe assembly (1423) being rotatable around a second axis (1473) allowing the first rotatable water supply pipe assembly (174) to be rotated around said second axis (1473). The first rotatable water supply pipe assembly (174) includes a straight pipe segment (171) to which said nozzle (170) is secured, a first elbow (173) and an outlet portion (1502) of a first rotatable coupling (1500), said first rotatable coupling (1500) further including an inlet portion (1504) which is part of said second rotatable water supply pipe assembly (1423). The fire suppression water cannon system further includes a vertical nozzle orientation drive motor (1404) coupled by a first moveable drive member to said first rotatable water supply pipe assembly (174) and a horizontal orientation drive motor (1407) coupled by a second moveable drive member to said second rotatable water supply pipe assembly (1423). A canister housing (165, 1204 or 1304) which can be and sometimes is inserted in or buried in the ground outside a house to be protected is used for storing said multi-axis nozzle assembly (1400) when said multi-axis nozzle assembly (1400) is not in use.

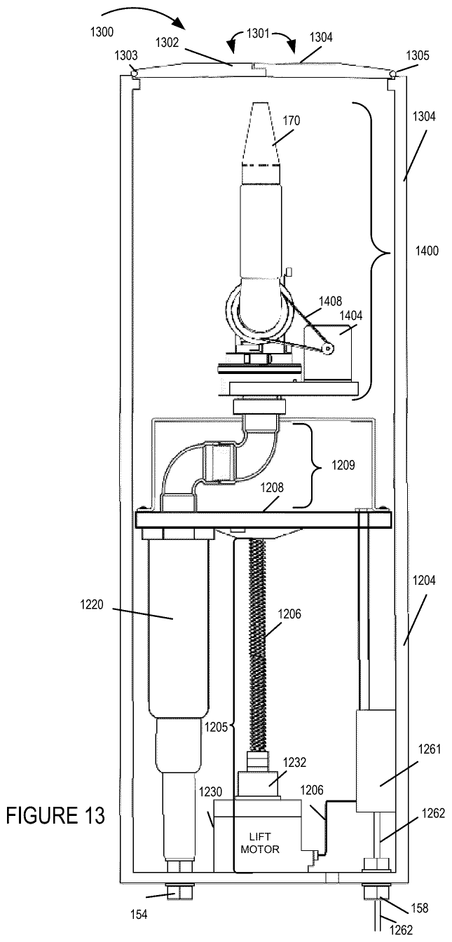

FIG. 13 shows a popup spray nozzle assembly 1300 similar to the one shown in FIG. 12 but with two top surface doors 1302, 1304 which in combination form a lid 1301. The doors 1402. 1304 of the lid 1301 are mounted on hinges 1302, 1305 in canister housing 1304. The doors 1302, 1304 interlock via a lip on the doors 1302, 2304 to provide a secure, strong, watertight seal when the water nozzle assembly 1400 is in the retracted state as shown in FIG. 13. The doors 1302, 1304 will spring open as the screw drive 1206 rotates and raises platform 1208 and the telescopic extendable tube 1220 extends to the position shown in FIG. 12.

FIG. 13 is a diagram 1300 showing the water cannon canister assembly including the second water cannon 1400 in a stored state with the lid of the canister 1304 in which the water cannon assembly 1400 is stored being in a closed state and the water cannon assembly 1400 being stored beneath the lid.

FIG. 14 is a diagram showing the second water cannon assembly 1400 of FIGS. 12 to 13 along with tilt 1404 and rotate 1407 position control motors along with other components such as dive belts 1408, 1420 and drive pulleys 1407, 1454 in greater detail than is shown in FIGS. 12 and 13. In FIG. 14 it can be seen that vertical position control motor 1404 has a pulley 1407 on an output shaft which when the motor rotates drives belt 1408 which in turn causes rotatable coupling portion 1502 of a first coupling 1500 to rotate. Since coupling outlet portion 1502 is secured to first pipe portion 171 via elbow 173 as coupling portion 1502 rotates nozzle 170 will move up or down allowing for control of the vertical orientation of the nozzle 170. In this way by rotating pulley 1407 and driving belt 1408 the vertical orientation of nozzle 170 can be changed. Rather than using a belt 1408 a combination of gears 902, 905 such as shown in FIG. 9 can be sued to change the orientation of nozzle 170.

Similarly, horizontal drive motor 1407 includes an output shaft on which vertically orientated pully 1454 is secured. By rotating the pully 1454 the belt 1420 is moved causing rotation of the moveable coupling portion 1502′ to which the elbow 173 is secured. Inlet portion 1504 of the second rotatable coupling 1500′ remains fixed to the and secure in the mounting bracket 1424 as the belt 1420 rotates. The inlet portion 1504′ of the second coupling 1500′ which includes rotatable portion 1502′ remains secure and fixed bracket 1452. Bracket 1450 secures the assembly 1400 to a mounting platform allowing the nozzle 170 to be rotated and titled via nozzle position control of motors 1404, 1407. Rather than use a belt 1420 and pully, gears can be and sometimes are used in place of the pully and belt 1420 shown in FIG. 14.

FIG. 15 shows a rotatable water coupling 1500 which can be used in any of the water cannon embodiments of the present application. The coupling includes a rotatable upper portion 1502 which is secured by water tight rotatable joint 1503 to inlet portion 1504. The coupling 1500 is used in some embodiments to secure the first pipe portion 171 to the second pipe portion 173 allowing the nozzle 170 to be raised and lowered. Another one of the couplings 1500 is sometime used to couple a water inlet t the nozzle assembly 1400 to the inlet of the second pipe portion 173 allowing rotation of the nozzle assembly 1400 around a vertical axis allowing the nozzle 170 to be pointed in any of 360 degrees available in the horizontal direction.

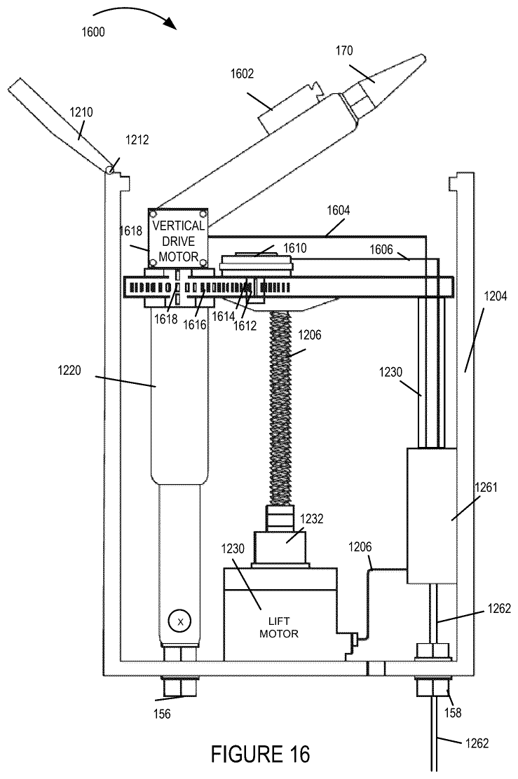

FIG. 16 is a diagram 1600 showing a third water cannon embodiment 1600 in a deployed state with a monitoring camera 1602 mounted facing the same direction as the water cannon nozzle 170 facilitating tracking of the water cannon spray and facilitating targeting of fires with the illustrated water cannon. In the FIG. 16 embodiment vertical drive motor 1618 controls vertical nozzle orientation while horizontal drive motor 1610 controls horizontal nozzle orientation by moving belt 1616 which drives shaft 1618 which causes the nozzle 170 to rotate in the horizontal direction as the shaft 1618 turns because of belt movement. Vertical drive motor control line 1604 is shown passing through conduit 1230 connecting controller 1261 to vertical drive motor 1618. Horizontal control line 1606 connects horizontal drive motor 1610 to controller 1261. Line 1206 coupled the lift motor 1230 to the controller 1261. Thus the controller 1261 can control the horizontal drive motor 1610, vertical drive motor 1618 and lift motor 1230.

In various embodiments a novel smart multi-axis lawn pop-up precision fire water cannon and associated system are used to protect a home or other structure (“property”) based on a custom 3D model in virtual space for the property being protected and real-time smart detection of fire when and where it arises. In some embodiments, the smart multi-axis lawn pop-up precision fire water cannon and system utilizes artificial intelligence (AI), infrared (IR) technology, and smart ember traps to detect and suppress fires endangering a home or structure. In some embodiments, the smart multi-axis lawn pop-up precision fire water cannon and system provides smart, precision-guided fire suppression that is customized for any given home or structure based on a 3D model of the home/structure and a controller configured to utilize the 3D model in conjunction with AI, IR technology, and/or smart ember traps to guide the smart, multi-axis, AI and IR controlled, precision fire, pop-up water cannon in its operation to suppress a fire.

In some embodiments, AI software running on a controller of the system is employed to control a plurality of smart multi-axis lawn pop-up precision fire water cannons that are environmentally sealed, automated, and used for remote wildfire structure suppression. In some embodiments, each smart multi-axis lawn pop-up precision fire water cannon is environmentally sealed so as not to damage internal electronics and actuators. Specifically, each smart multi-axis lawn pop-up precision fire water cannon of the system is fully capable of being controlled by any one of, or a combination of, (i) a remote user app, (ii) one or more onsite cameras, (iii) one or more IR sensors, and (iv) one or more smart ember traps. In some embodiments, the property and area around the property is accurately pre-mapped in virtual 3D space with the resulting 3D model being stored on an on-site computer or data storage structure or database that is communicably connected to, and accessible by, a computing device. In some embodiments, the 3D model provides real-time automated control of each smart multi-axis lawn pop-up precision fire water cannon deployed on-site to pinpoint and put out flames exactly where they arise. Furthermore, the smart multi-axis lawn pop-up precision fire water cannons can be installed as an add-on to a normal permitted home or structure irrigation system and each smart multi-axis lawn pop-up precision fire water cannon of the system may be hardwired for communication of control information or wireless for communication and control. In addition, the smart multi-axis lawn pop-up precision fire water cannons can be remote controlled through a joystick phone app and onsite cameras as another option. When the plurality of smart multi-axis lawn pop-up precision fire water cannons of the system are deployed for automated operation, such that the full system can be used for extinguishing wildfires and as a precision IR tool water cannon used on illegal trespassers to discourage them off the property. In some embodiments, the smart multi-axis lawn pop-up precision fire water cannon is not a lawn-based, pop-up canon, but instead is a non-pop up, waterproof canon with two axis smaller units that are designed to hang under structure eaves at the ends of a home's roof. These non-pop up canons perform the same guided function as those pop-up lawn-based canons described above, but are designed to mount at different angles to provide additional suppression coverage.

Having thus described the invention in general terms, reference is now made to the accompanying drawings, which are not necessarily drawn to scale, and which show different views of different example embodiments.

Embodiments of the invention described in this specification include a smart multi-axis lawn pop-up precision fire water cannon and associated system for protection of a property based on a custom 3D model in virtual space for the property being protected and real-time smart detection of fire when and where it arises. In some embodiments, the smart multi-axis lawn pop-up precision fire water cannon and system utilizes AI, IR technology, and smart ember traps to detect and suppress fires endangering a property. In some embodiments, the smart multi-axis lawn pop-up precision fire water cannon and system provides smart, precision-guided fire suppression that is customized for any given home or structure based on a 3D model of the home/structure and a controller configured to utilize the 3D model in conjunction with AI, IR technology, and/or smart ember traps to guide the smart, multi-axis, AI and IR controlled, precision fire, pop-up water cannon in its operation to suppress a fire.

In some embodiments, AI software running on a controller of the system is employed to control a plurality of smart multi-axis lawn pop-up precision fire water cannons that are environmentally sealed, automated, and used for remote wildfire structure suppression. In some embodiments, each smart multi-axis lawn pop-up precision fire water cannon is environmentally sealed so as not to damage internal electronics, actuators, or motors. Specifically, each smart multi-axis lawn pop-up precision fire water cannon of the system is fully capable of being controlled by any one or a combination of (i) a remote user app, (ii) one or more onsite cameras, (iii) one or more IR sensors, and (iv) one or more smart ember traps. In some embodiments, the property and area surrounding the property is accurately pre-mapped in virtual 3D space with the resulting 3D model being stored on an on-site computer or data storage structure or database that is communicably connected to, and accessible by, a computing device. In some embodiments, the 3D model provides real-time automated control of each smart multi-axis lawn pop-up precision fire water cannon of the system deployed on-site to pinpoint and put out flames exactly where they arise. Furthermore, the smart multi-axis lawn pop-up precision fire water cannons can be installed as an add-on to a normal permitted home or structure irrigation system and each smart multi-axis lawn pop-up precision fire water cannon may be hardwired for system-wide communication of control information or wireless (WiFi, Bluetooth, etc.) for communication and control. In addition, the smart multi-axis lawn pop-up precision fire water cannons deployed for the system can be remote controlled through a joystick phone app and onsite cameras as another option. When the plurality of smart multi-axis lawn pop-up precision fire water cannons are deployed for automated operation, the full system can be used for extinguishing wildfires and as a precision IR tool water cannon used on illegal trespassers to discourage them off the property.

As stated above, wildfires present increasingly greater risk to homeowners and residents in dwellings, no matter how near or far they are from firefighting services. This is a problem for individuals who wish to prevent fires from destroying or damaging their homes. Consequently, many residents deploy and then plan to utilize water sprinklers or unguided water cannons as fire suppression/prevention devices. However, these conventional devices are configured to just spray water in a single direction, or spray water over a range in repeated fashion, without ever detecting where the greatest fire damage is happening. Thus, these conventional home fire devices fail to prevent all damage from fires and often fail altogether since fires can be relentless when not fully suppressed. Embodiments of the smart multi-axis lawn pop-up precision fire water cannon and associated system described in this specification solve such problems by a smart fire suppression system with one or more smart multi-axis lawn pop-up precision fire water cannons that are controlled by a remote user app and/or automated by onsite IR cameras and sensors, smart ember traps, and/or AI-based fire prediction, and customized for any given property (home or other structure) based on an accurately pre-mapped 3D model as a digitized model in virtual 3D space accessible to a controller-based, onsite computing device. In this way, the system provides real-time automated control of the smart multi-axis lawn pop-up precision fire water cannons to pinpoint and put out wildfire flames with less water. Operation may be remote controlled (e.g., by a human user interacting with the app) or autonomous. Operation includes suppression of fires in real-time, but also includes other operations, such as pre-soaking the property at various mapped hazard points identified for further pre-fire protection and testing, and other AI based features. This is a vast improvement over the existing systems (of which some are installed un-permitted) including standard irrigation sprinklers on roofs, preset patterns at a house in the hopes of blindly putting out dangerous wildfire embers and flames with no smart data, and no remote control of the suppression systems.

Embodiments of the smart multi-axis lawn pop-up precision fire water cannon and associated system described in this specification differ from and improve upon currently existing options. In particular, there are no smart pre-mapped computer modeled virtual 3D model-based water cannons or other fire suppression device for commercial or home wildfire suppression. Instead, the existing fire suppression and fire mitigation devices are simple devices that spray water in a single location or pattern, without any intelligence to detect where the fire may present the greatest threat in real-time. In short, the existing options do not provide smart technology that is able to detect (or know) where the fire or embers are in 3D space. Instead, they operate blind and cannot gauge water with precision with computer control and sensors (IR, ember traps, etc.) to the exact spot to put out fire. By contrast, the smart multi-axis lawn pop-up precision fire water cannon and associated system utilizes smart IR-mapping along with normal security camera(s) and thermal imagery to pin-point flames and embers using a smart GPU image processing algorithm software in a lab fire testing environment. Similarly, the smart multi-axis lawn pop-up precision fire water cannon and associated system utilizes smart ember traps for the same, where the ember traps are installed on or around the property (home or other structure).

The smart multi-axis lawn pop-up precision fire water cannon and associated system of the present disclosure may be comprised of the following elements. This list of possible constituent elements is intended to be exemplary only and it is not intended that this list be used to limit the smart multi-axis lawn pop-up precision fire water cannon and associated system of the present application to just these elements. Persons having ordinary skill in the art relevant to the present disclosure may understand there to be equivalent elements that may be substituted within the present disclosure without changing the essential function or operation of the smart multi-axis lawn pop-up precision fire water cannon and associated system.

In some embodiments one or more smart multi-axis lawn pop-up precision fire water cannon(s) are used. Each smart multi-axis lawn pop-up precision fire water cannon is at least a 2-axis cannon (but may also include 3-axis or more) but this is not the case in all embodiments. In some embodiments, the smart multi-axis lawn pop-up precision fire water cannon comprises an embedded microprocessor and is environmentally sealed and designed to be controlled autonomously for on-site control or controlled via wireless, remote control (e.g., WiFi or hardwired) for remote-based control. Notably, the smart multi-axis lawn pop-up precision fire water cannon is an environmentally sealed, self-contained unit that can be added on to any standard home irrigation system. However, alternate embodiments of the smart multi-axis lawn pop-up precision fire water cannon are not configured as pop-up water cannons.

Servo actuators for pitch control and a flexible hose that allow vertical motion and flow of water of the smart multi-axis lawn pop-up precision fire water cannon.

An integrated wireless controller or hardwired internet data communication connections control device 161 that is configured to control small, rugged, long lasting servo actuators and or solenoids to control pop-up rotation and nozzle pitch of each smart multi-axis lawn pop-up precision fire water cannon is used in some embodiments.

Artificial Intelligence (AI) smart software and 3D modeling software in conjunction with virtual 3D modeled onsite cameras is used in some embodiments. This provides precision fire suppression for long periods of time.

Smart image processing software is used in some embodiments. Since multiple security cameras, IR sensors, and smart ember traps are deployed at multiple locations on and around the property being protected (due to the potential for water spray blocking or distorting images), the system includes smart image processing software to process imagery from the multiple cameras, sensors, and smart ember traps to triangulate and pinpoint flames and embers to suppress. As such, smart GPU image processing software perfected in a lab environment is uploaded to a home computer server and the real-time camera and IR data is processed to determine how to guide each of the several smart multi-axis lawn pop-up precision fire water cannons deployed around the property to the exact wildfire flame and ember positions. Then the positions are transmitted to each smart multi-axis lawn pop-up precision fire water cannon to rotate the water cannon head and pitch up the nozzle to precisely extinguish the embers and flames.

The smart multi-axis lawn pop-up precision fire water cannons are rugged, environmentally sealed, and equipped with flexible hosing and multi-axis control. Notably, while the preferred embodiment of the smart multi-axis lawn pop-up precision fire water cannon is a pop-up design, other embodiments of the smart multi-axis water cannon are not designed as pop-up cannons, but are elevated above ground from the start. Nevertheless, the smart multi-axis lawn pop-up precision fire water cannons designed as pop-up versions are environmentally sealed in containers that are impervious to dust and water seepage, thus providing concealed and a non-tripping hazard cannon with full protection of the electronics and internal components, and also ensuring that the part will not freeze up over time.

Software and/or circuits are used in some embodiments to control the smart multi-axis lawn pop-up precision fire water cannons is implemented to extract camera, IR sensor, and ember trap GPS positions and GPU-based AI algorithms to perfect cannon control. Image processing software is integrated or accessed to learn to see though smoke to see small flame locations with precision using multiple sensors and data location triangulation algorithms. Software is deployed in some embodiments with the smart multi-axis lawn pop-up precision fire water cannons as an operational component of the system, e.g., a control program or sub-program. Thus, the system would deploy a computing device at the property (or communicably connected to the property) and the software and/or embedded hardware is configured in some embodiments to control fire suppression system operation.

A virtual 3D model is used in some embodiments to map and modeling the property/site as a three-dimensional (3D) model. The model includes all the exact 3D locations of the water cannons, cameras, sensors, ember traps, vegetation, surrounding structures and items, etc., in relation to the actual home/structure (property) as accurately as possible for a computer-generated 3D model. This allows the real-time processed data from the cameras, sensors, and ember traps to be processed to pinpoint dangerous flames and embers. Operation control data is then sent to the smart multi-axis lawn pop-up precision fire water cannon and its microprocessor to direct water onto the flames to extinguish them. Automated real-time feedback can then determine further suppression options for the water cannons to perform.

A machine learning system to train the AI model based on data points collected by and provided by the camera(s), IR sensor(s), thermal imaging, UV wildfire image detection, etc. is supported and used in some embodiments. The data points are used to understand where fire arises in real-time and, thereby, to provided precision-fired water from one or more of the smart multi-axis lawn pop-up precision fire water cannons. The AI, GPU, computing device, and/or smart computers learn to recognize flames and ember conditions around the property. The machine learning system trains the AI model to detect with ever-increasing precision fire and fire risk for the property based on training and retraining of the model according to the data points collected and detected by the cameras, IR sensors, thermal image, and UV detection data. Examples of training data include, without limitation, a variety of ember sizes, vegetation (at various growth points and seasonal changes), concentrations, and heat signatures, among other training data. Furthermore, the training data can inform the system and can be learned in different environmental conditions to be used as an early warning system for home wildfire detection.

Ember traps 173 in some embodiments are smart ember traps (or ember detectors) installed on the structure of the property or nearby and around the property.

The various elements of the smart multi-axis lawn pop-up precision fire water cannon and associated system of the present disclosure may be related in the following exemplary fashion. It is not intended to limit the scope or nature of the relationships between the various elements and the following examples are presented as illustrative examples only. The property/site is mapped, and 3D modeled virtually on a computer. All the exact 3D locations of the water cannons, cameras, sensors, and ember traps in relation to the structure and surrounding vegetation are accurately generated as a model on the computer. This allows the real-time processed data from the cameras to pinpoint dangerous flames and embers. Then data can be sent to one or more of the smart multi-axis lawn pop-up precision fire water cannons deployed on-site. The embedded microprocessor of the smart multi-axis lawn pop-up precision fire water cannon may then direct water onto the flames to extinguish them. Automated real-time feedback can then determine further suppression options for the smart multi-axis lawn pop-up precision fire water cannons to perform. This automation of a standard pop-up in some embodiments uses integrated wireless control or hardwired internet connections. Small rugged servo actuators and solenoids are used to control pop-up rotation and nozzle pitch. The pitch control of the cannon nozzles uses servo actuators and a flexible hose that allows vertical motion and guided flow of high-pressure water. Security cameras with exact GPS positions and IR sensors are understood so as to provide precision cannon control. Image processing software and machine learning system are utilized to train the AI for the system to see through smoke to see small flame locations with precision using multiple sensors and data location triangulation algorithms. System software controls the multitude of smart multi-axis lawn pop-up precision fire water cannons based on training from multiple data points collected continuously and in real-time.

The smart multi-axis lawn pop-up precision fire water cannon and associated system of the present disclosure generally works by AI technology, smart image processing, IR sensors, image capture via multiple cameras, and data collected by a smart ember traps in connection with a pre-made virtual site dependent model (3D model of the property and surrounding area along with the precise GPS location data for the IR sensors, cameras, ember traps, etc. In particular, the artificial intelligence system includes an AI software system that is employed to control the environmentally sealed smart multi-axis lawn pop-up precision fire water cannons which are the core components used for wildfire structure suppression and a fully capable of being controlled by a remote user app or autonomously via onsite cameras, smart ember traps, and IR sensors.

To make the smart multi-axis lawn pop-up precision fire water cannon and associated system of the present disclosure, 2-axis water cannons are used in some embodiments (but 3-axis canon or more axis cannons are used in other embodiments) with control actuators, servos, and embedded control microprocessor. Precision servomotors, stepper motors and solenoid control the heading and pitch and pressure of each smart multi-axis lawn pop-up precision fire water cannon to precisely put out the fire is preferred. The person would ensure there is an off-grid water supply and power for the smart multi-axis lawn pop-up precision fire water cannons and hardwired or WiFi/Bluetooth/other wireless data transmission between a computing device and each smart multi-axis lawn pop-up precision fire water cannon. The computing device would be configured to store and provide access to runtime processing of a virtual onsite 3D computer model of the property and surrounding area/structure, with precision location detection and positional computer modeling of the IR thermal sensors, cameras, ember traps, etc. The person would also provide or create smart site-based software that can process the imagery for cameras to triangulate the thermal signatures of the hot spots on the property or structure to send control data to the guided water cannons for precision fire extinguishing. The person may wish to integrate the system with an existing-sprinkler irrigation system of the property.

To use the smart multi-axis lawn pop-up precision fire water cannon and associated system of the present disclosure, a person can simply ensure that deployment of all components and items is completed. Then the system operates autonomously to protect structures and property from wildfires and the embers they produce. While the smart multi-axis lawn pop-up precision fire water cannon works optimally with smart ember detectors deployed, it is possible to deploy without such ember detectors. Similarly, the system may be deployed with a mesh network of sensors configured to activate the computing device and associated software system that provide real-time operational control of the smart multi-axis lawn pop-up precision fire water cannons, based on the various data points collected by the sensors, cameras, traps, etc. Specifically, the IR thermal cameras and sensors determine where hot spots arise, embers or fire on the structure is detected, or signs of excess heat, embers, fire in and around (or on) the surrounding area and items nearby the property. Collectively, these sensors then send the collected data to the local processing computing device for evaluation by the software system. The onboard virtual computer 3D model of the property and surrounding area are utilized in order to send control data to the micro-processor and control system components of the smart multi-axis lawn pop-up precision fire water cannons to precisely guide the cannons to the hot spots, in order to extinguish the fire, or soak an area of the house that is heating up, thereby saving the property or (at the very least) mitigating fire damage to the property, all without human intervention. Note, however, a remote smartphone application can and also is used by a person to control the smart multi-axis lawn pop-up precision fire water cannons remotely as another method of suppression. While human intervention is allowed by the system, a human user's involvement does not derail the system's ability to operate autonomously.

### Exemplary Numbered Embodiments

Exemplary numbered embodiment 1 A fire suppression water cannon system comprising: a multi-axis nozzle assembly (1400) including: a nozzle (170); a first rotatable water supply pipe assembly (174) having a first end to which said nozzle (170) is secured, said first rotatable water supply pipe assembly (174) being rotatable around a first axis (1471) (e.g., a horizontal axis) allowing for adjustment of a vertical orientation of said first rotatable water supply pipe assembly (174); and a second rotatable water supply pipe assembly (1423) coupled to said first rotatable water supply pipe assembly (174), said second rotatable water supply pipe assembly (1423) (e.g. including rotatable coupling portion 1504, second elbow 1421 and outlet portion 1502′ of the second rotatable coupling generally indicated by arrow 1500′) being rotatable around a second axis (1473) (e.g., vertical axis) allowing the first rotatable water supply pipe assembly (174) to be rotated around said second axis (1473).

Exemplary numbered embodiment 2 The fire suppression water cannon system of Exemplary numbered embodiment 1, wherein said first rotatable water supply pipe assembly (174) includes a straight pipe segment (171) to which said nozzle (170) is secured, a first elbow (173) and an outlet portion (1502) of a first rotatable coupling (1500), said first rotatable coupling (1500) further including an inlet portion (1504) which is part of said second rotatable water supply pipe assembly (1423).

Exemplary numbered embodiment 3 The fire suppression water cannon system of Exemplary numbered embodiment 2, further comprising: a vertical nozzle orientation drive motor (1404) coupled by a first moveable drive member (belt 1408 or one or more gears) to said first rotatable water supply pipe assembly (174).

Exemplary numbered embodiment 4 The fire suppression water cannon system of Exemplary numbered embodiment 3, further comprising: a horizontal orientation drive motor (1407) coupled by a second moveable drive member (belt 1420 or one or more gears) to said second rotatable water supply pipe assembly (1423).

Exemplary numbered embodiment 5 The fire suppression water cannon system of Exemplary numbered embodiment 4, further comprising:
a canister housing (165 or 1304) for storing said multi-axis nozzle assembly (1400) when said multi-axis nozzle assembly (1400) is not in use.

Exemplary numbered embodiment 6 The fire suppression water cannon system of Exemplary numbered embodiment 5, wherein said canister housing (165 or 1304) is buried in ground outside a house to be protected from fire.

Exemplary numbered embodiment 7 The fire suppression water cannon system of Exemplary numbered embodiment 5, further comprising: an extendable water supply (1220) for supplying water to said second rotatable water supply pipe assembly (1423).

Exemplary numbered embodiment 8 The fire suppression water cannon system of Exemplary numbered embodiment 7, wherein said extendable water supply (1220) is a telescoping pipe or coiled hose.

Exemplary numbered embodiment 9 The fire suppression water cannon system of Exemplary numbered embodiment 7, further comprising: a moveable lid (1210 or 1301 including combination of 1302 and 1304) for sealing the multi-axis nozzle assembly (1400) in said canister housing (165, 1204 or 1304) when not in use.

Exemplary numbered embodiment 10 The fire suppression water cannon system of Exemplary numbered embodiment 7, further comprising: a multi-axis nozzle assembly (1400) lift mechanism (combination of 1206, 1232 and 1230) for moving said multi-axis nozzle assembly (1400) to a deployed state when the multi-axis nozzle assembly (1400) is to be used for spraying water.

Exemplary numbered embodiment 11 The fire suppression water cannon system of Exemplary numbered embodiment 10, wherein the lift mechanism includes a lift motor (1230) and a drive screw (1206) for moving the multi-axis nozzle assembly (1400) upward to a deployed position when water is to be sprayed and for moving the multi-axis nozzle assembly (1400) downward to a storge position within the canister housing (165 or 1304) when the multi-axis nozzle assembly (1400) is not being used.

Exemplary numbered embodiment 12 The fire suppression water cannon system of Exemplary numbered embodiment 11, further comprising: a controller (1261) coupled to said lift motor (1230) for controlling the lift motor to move the multi-axis nozzle assembly (1400) upward to the deployed position when water is to be spayed and controlling the lift motor to move the multi-axis nozzle assembly (1400) downward to the storage position inside said canister housing (165 or 1304) for storage when the multi-axis nozzle assembly (1400) is not in use (e.g., not being used to spray water).

Exemplary numbered embodiment 13 The fire suppression water cannon system of Exemplary numbered embodiment 12, wherein said controller (1261) is further coupled to the vertical nozzle orientation drive motor (1404) and horizontal orientation drive motor (1407).

Exemplary numbered embodiment 14 The fire suppression water cannon system of Exemplary numbered embodiment 13, further comprising: one or more control lines (1262) coupling said controller to a control system (132) located inside a house, said fire suppression water cannon system being located outside said house.

Exemplary numbered embodiment 15 The fire suppression water cannon system of Exemplary numbered embodiment 14, wherein said controller (1261) controls said vertical nozzle orientation drive motor (1404) and horizontal orientation drive motor (1407) to move said nozzle 170 as directed by the control system (132) located inside a house.

Exemplary numbered embodiment 16 The fire suppression water cannon system of Exemplary numbered embodiment 15, wherein said control system (132) located inside the house directs the controller (1261) to move said nozzle (170) based on the location a detected fire or position control signals received from a user device (150) in communication with said control system (132).

Exemplary numbered embodiment 17 A multi-axis fire suppression water cannon system comprising: a multi-axis water nozzle assembly including: a nozzle (170); a first rotatable water supply pipe (171) connected at a first end to the nozzle (170) (e.g., using threads, press on connection or via direct connection); a second rotatable water supply pipe (173) movably connected to the first rotatable water supply pipe (e.g., using a rotatable water tight connection or coupling), said first rotatable water supply pipe being at least partially rotatable around a first axis (e.g., water supply pipe portion 171 is rotatable in the vertical direction (up/down) as the portion 171 moves around a horizontal axis corresponding to the horizontal axis of vertical drive gear shaft 906 on which gear 905 is located, gear 905 being engaged with and driving vertical direction drive gear 902 as vertical drive motor assembly 904 turns drive shaft 906, said second rotatable water supply pipe 173 being at least partially rotatable around a second axis, e.g., a vertical axis corresponding to horizontal direction motor drive shaft 107, which is extends in the vertical direction and drives horizontal direction drive gear 105 which is mounted on shaft 107. Horizontal direction drive gear 105 has teeth which engage teeth of nozzle head assembly horizontal direction drive gear 930 with rotation of horizontal direction drive gear 105 causing the nozzle head assembly (166) to rotate); and a water inlet 156 (e.g., e.g., threaded opening for connection to a water supply line or other opening formed from walls of canister housing 165) coupled to the second rotatable water supply pipe (e.g., via a flexible tube or water passage/cavity 177) for supplying water through the second rotatable water supply pipe 173 and first rotatable water supply pipe (171) to the nozzle (170).

Exemplary numbered embodiment 18 The fire suppression water cannon of Exemplary numbered embodiment 17, further comprising: a vertical drive motor (904) with an output shaft (906) mechanically coupled to the first water supply pipe (171) by a drive assembly (e.g., motor output gear 905 and first water supply pipe drive gear each having teeth which engage the teeth of the other gear allowing the vertical drive motor (904) to control the vertical orientation of the nozzle (170).

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details.

Various embodiments are directed to a non-transitory machine readable storage device, e.g., memory, with processor executable instructions stored thereon, which when executed by a processor of an apparatus, e.g., access point or station, control the apparatus to implement any one or more of the above described methods or numbered method embodiments.

The techniques of various embodiments may be implemented using software, hardware and/or a combination of software and hardware. Various embodiments are directed to apparatus. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., controllers, water cannons and/or elements described herein are implemented using one or more components to perform the steps corresponding to one or more method. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, are configured to perform the steps of the methods described as being performed by the user equipment devices, water cannons and/or the fire suppression system controller described herein. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device with a processor which includes a component corresponding to each of the steps of the various described methods performed by the device in which the processor is included. In some but not all embodiments a device, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., water cannon or fire suppression system. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A fire suppression water cannon system comprising:
a multi-axis nozzle assembly (1400) including:
a nozzle (170);
a first rotatable water supply pipe assembly (174) having a first end to which said nozzle (170) is secured, said first rotatable water supply pipe assembly (174) being rotatable around a first axis (1471) (e.g., a horizontal axis) allowing for adjustment of a vertical orientation of said first rotatable water supply pipe assembly (174); and
a second rotatable water supply pipe assembly (1423) coupled to said first rotatable water supply pipe assembly (174), said second rotatable water supply pipe assembly (1423) being rotatable around a second axis (1473) allowing the first rotatable water supply pipe assembly (174) to be rotated around said second axis (1473).

2. The fire suppression water cannon system of claim 1, wherein said first rotatable water supply pipe assembly (174) includes a straight pipe segment (171) to which said nozzle (170) is secured, a first elbow (173) and an outlet portion (1502) of a first rotatable coupling (1500), said first rotatable coupling (1500) further including an inlet portion (1504) which is part of said second rotatable water supply pipe assembly (1423).

3. The fire suppression water cannon system of claim 2, further comprising:
a vertical nozzle orientation drive motor (1404) coupled by a first moveable drive member to said first rotatable water supply pipe assembly (174).

4. The fire suppression water cannon system of claim 3, further comprising:
a horizontal orientation drive motor (1407) coupled by a second moveable drive member to said second rotatable water supply pipe assembly (1423).

5. The fire suppression water cannon system of claim 4, further comprising:
a canister housing (165, 1204 or 1304) for storing said multi-axis nozzle assembly (1400) when said multi-axis nozzle assembly (1400) is not in use.

6. The fire suppression water cannon system of claim 5, wherein said canister housing (165, 1204 or 1304) is buried in ground outside a house to be protected from fire.

7. The fire suppression water cannon system of claim 5, further comprising:
an extendable water supply (1220) for supplying water to said second rotatable water supply pipe assembly (1423).

8. The fire suppression water cannon system of claim 7, wherein said extendable water supply (1220) is a telescoping pipe or coiled hose.

9. The fire suppression water cannon system of claim 7, further comprising:
a moveable lid (1210 or 1301) for sealing the multi-axis nozzle assembly (1400) in said canister housing (165, 1204 or 1304) when not in use.

10. The fire suppression water cannon system of claim 7, further comprising:
a multi-axis nozzle assembly (1400) lift mechanism (1205) for moving said multi-axis nozzle assembly (1400) to a deployed state when the multi-axis nozzle assembly (1400) is to be used for spraying water.

11. The fire suppression water cannon system of claim 10, wherein the lift mechanism (1205) includes a lift motor (1230) and a drive screw (1206) for moving the multi-axis nozzle assembly (1400) upward to a deployed position when water is to be sprayed and for moving the multi-axis nozzle assembly (1400) downward to a storge position within the canister housing (165 or 1304) when the multi-axis nozzle assembly (1400) is not being used.

12. The fire suppression water cannon system of claim 11, further comprising:
a controller (1261) coupled to said lift motor (1230) for controlling the lift motor to move the multi-axis nozzle assembly (1400) upward to the deployed position when water is to be spayed and controlling the lift motor to move the multi-axis nozzle assembly (1400) downward to the storage position inside said canister housing (165 or 1304) for storage when the multi-axis nozzle assembly (1400) is not in use (e.g., not being used to spray water).

13. The fire suppression water cannon system of claim 12, wherein said controller (1261) is further coupled to the vertical nozzle orientation drive motor (1404) and horizontal orientation drive motor (1407).

14. The fire suppression water cannon system of claim 13, further comprising:
one or more control lines (1262) coupling said controller to a control system (132) located inside a house, said fire suppression water cannon system being located outside said house.

15. The fire suppression water cannon system of claim 14, wherein said controller (1261) controls said vertical nozzle orientation drive motor (1404) and horizontal orientation drive motor (1407) to move said nozzle 170 as directed by the control system (132) located inside a house.

16. The fire suppression water cannon system of claim 15, wherein said control system (132) located inside the house directs the controller (1261) to move said nozzle (170) based on the location a detected fire or position control signals received from a user device (150) in communication with said control system (132).

17. A multi-axis fire suppression water cannon system comprising:
a multi-axis water nozzle assembly including:
a nozzle (170);
a first rotatable water supply pipe (171) connected at a first end to the nozzle (170) (e.g., using threads, press on connection or via direct connection);
a second rotatable water supply pipe (173) movably connected to the first rotatable water supply pipe (e.g., using a rotatable water tight connection or coupling), said first rotatable water supply pipe being at least partially rotatable around a first axis (e.g., water supply pipe portion 171 is rotatable in the vertical direction (up/down) as the portion 171 moves around a horizontal axis corresponding to the horizontal axis of vertical drive gear shaft 906 on which gear 905 is located, gear 905 being engaged with and driving vertical direction drive gear 902 as vertical drive motor assembly 904 turns drive shaft 906, said second rotatable water supply pipe 173 being at least partially rotatable around a second axis, e.g., a vertical axis corresponding to horizontal direction motor drive shaft 107, which is extends in the vertical direction and drives horizontal direction drive gear 105 which is mounted on shaft 107. Horizontal direction drive gear 105 has teeth which engage teeth of nozzle head assembly horizontal direction drive gear 930 with rotation of horizontal direction drive gear 105 causing the nozzle head assembly (166) to rotate); and
a water inlet 156 coupled to the second rotatable water supply pipe for supplying water through the second rotatable water supply pipe 173 and first rotatable water supply pipe (171) to the nozzle (170).

18. The fire suppression water cannon of claim 17, further comprising:
a vertical drive motor (904) with an output shaft (906) mechanically coupled to the first water supply pipe (171) by a drive assembly.

19. The fire suppression water cannon of claim 18, wherein the drive assembly includes a motor output gear (905).

20. The fire suppression water cannon of claim 19 wherein the drive assembly further includes a first water supply pipe drive gear (902) having teeth which engage the teeth of the motor output gear (905) allowing the vertical drive motor (904) to control the vertical orientation of the nozzle (170).
